(19) United States
(12) Patent Application Publication
(10) Pub. No.: US 2012/0271891 A1
(43) Pub. Date: Oct. 25, 2012

(54) COMMUNICATION SYSTEM, COMMUNICATION METHOD AND USER MANAGEMENT SERVER

(75) Inventor: Yasuyuki Sugitani, Funabashi-shi (JP)

(73) Assignee: DWANGO CO., LTD., Tokyo (JP)

(21) Appl. No.: 13/393,600

(22) PCT Filed: Oct. 14, 2010
(86) PCT No.: PCT/JP2010/068064

§ 371 Date: Mar. 1, 2012

(30) Foreign Application Priority Data
Nov. 13, 2009 (JP) 2009-260170
Aug. 3, 2010 (JP) 2010-174391

(51) Int. Cl. G06F 15/16

(52) U.S. Cl. 709/206

(57) ABSTRACT

A user management server stores access information which is created by associating each item of access identification information, which identifies an access destination in accordance with the number of users who have been permitted to connect to it, together with access conditions which show the attributes of users, and with user identification information which identifies the user terminals associated with this access destination, and with connection destination information which identifies a comment storage section where the comments transmitted from the user terminals are stored, and when a connection request is received from a user terminal, then if a vacancy exists in the access information which has been associated with the corresponding access conditions, the connection is permitted, and if a comment server receives a comment transmitted from a user terminal, it shares this comment with the user terminals with which this same connection destination information has been associated.

### TECHNICAL FIELD

The present invention relates to a communication system in which comments that are input so as to match the progress of played contents are shared between a plurality of user terminals, and also to a communication method, and a user management server.

Priority is claimed on Japanese Patent Application Nos. 2009-260170, filed Nov. 13, 2009 and 2010-174391, filed Aug. 3, 2010, the contents of which are incorporated herein by reference.

### BACKGROUND ART

Communication services now exist that deliver comments transmitted from a plurality of user terminals that are connected together via a network, and provide a site for communication between users. For example, in Patent document 1, a communication service is described that manages communication by dividing comments transmitted on a chat service from a large number of user terminals between a plurality of comment servers. According to this system, when a large number of user terminals are using a communication service, it is possible to reduce the number of comments managed by each individual comment server, and distribute the processing load.

In recent years, communication services have been provided that share between a plurality of user terminals comments which are input into user terminals to match the progress of contents being played on the user terminals. In communication services such as this, it is thought that even if all of the comments transmitted from a large number (for example, tens of thousands) of user terminals are delivered to all of the user terminals, it is still difficult for the users of the user terminals who receive the large number of comments to read and comprehend all of the comments. For this reason, if the same communication service is being used by a large number of user terminals, the comment number can be controlled by dividing the large number of user terminals between a plurality of groups with a fixed number of terminals being allocated to each group, such that each one of the groups belongs to a virtual room. Here, by only allowing comments to be transmitted and received between user terminals that belong to the same room, it is possible to provide a communication service that limits the number of users to a number that allows communication to be performed smoothly.

### DOCUMENTS OF THE PRIOR ART

### Patent Documents

[Patent document 1] Japanese Unexamined Patent Application, First Publication (JP-A) No. 10-334021

### DISCLOSURE OF INVENTION

### Problems to be Solved by the Invention

However, in a communication service such as that described above, if a large number of user terminals are divided between a plurality of rooms, then, generally, rooms are allocated to the users following the sequence in which connection requests were sent from the user terminals to the comment servers. Namely, users belonging to the same room are decided passively irrespective of their attributes and the like. Because of this, it is likely that there are cases in which smooth communication may not be achieved because of the lack of topics common to users belonging to the same room. Moreover, if, for example, the provider of the communication service attempts to provide a communication service that follows specific topics, then it is likely that users having a particular common interest will want to belong to the same room. Therefore, in a communication service that divides a plurality of users into arbitrary units in the aforementioned manner and then makes them communicate with each other within these division units (i.e., rooms), it is desirable for the rooms to be divided such that common interests exist between users who belong to the same room.

The present invention was conceived in view of the above described circumstances. The present invention provides a communication system, a communication method, and a user management server that, when users who are using a communication service are divided into arbitrary division units, makes the divisions such that communication between users within a division unit is able to proceed smoothly.

### Means for Solving the Problem

In order to solve the above described problems, the present invention is a communication system that includes: a comment server that receives comments transmitted from a plurality of user terminals, and then delivers the received comments to the plurality of user terminals so that they are displayed thereon; and a user management server that receives requests to connect to a communication service which is provided by the comment server from the user terminals, wherein the user management server includes: a user information storage section which stores user identification information which identifies the user of the user terminal and user attribute information which shows the attributes of that user in association with each other, as user information; an access information storage section which stores access identification information which identifies an access destination in accordance with the number of users who have been permitted to connect to the communication service, access conditions which show the attributes of the users of this access destination, the user identification information which identifies the user terminals of this access destination, and connection destination information which specifies one comment storage section from among a plurality of comment storage sections that are provided in the comment server in order to store the comments transmitted from the user terminals of this access destination in association with each other, as access information; and an access control section that receives the connection request transmitted from the user terminal, reads the user attribute information that corresponds to that user terminal from the user information storage section, and determines whether or not there is access information with which the user identification information has not been associated among the plurality of access information items that satisfy the access conditions in accordance with the read user attribute information, and if it determines that there is access information with which the user identification information has not been associated, permits the connection and associates the relevant user terminal with the relevant access information and stores this association in the access information storage section, while if it determines that there is not such access information, does not permit the connection and does not associate the relevant user terminal with the relevant access information, and wherein the comment server includes: the plurality of comment storage sections in which the comments transmitted from the user terminals are stored; a comment receiving section that receives the comments transmitted from the user terminals, and stores the received comments in that comment storage section out of the plurality of comment storage sections which is specified by the connection destination information which has been stored so as to correspond to the relevant user terminal; and a comment delivery section which delivers the comments stored in the comment storage section to the user terminal with which the relevant comment storage section is associated as connection destination information.

Moreover, in the communication system of the present invention, it is also possible for the access information storage section to store temporary attribute information which shows the attributes of a particular user which are decided temporarily by that user as the access conditions that associate that user with the access destination, and for the access control section to receive the temporary attribute information from the user terminal together with the connection request, and to compare the received temporary attribute information with the access conditions stored in the access information storage section, and to determine the access information with which that particular user terminal is to be associated.

Moreover, in the communication system of the present invention, it is also possible for the user information stored in the user information storage section to include information showing the level of priority of a particular user, and, when the access control section determines that the access information with which the user identification information has not been associated is not present among the plurality of access information items that satisfy the access conditions in accordance with the relevant user attribute information that corresponds to the user terminal which is the source of the connection request transmission, for it to compare a first priority level which corresponds to the user terminal which is the source of the connection request transmission with a second priority level which corresponds to the users who are associated with the access information, and if a user with whom a priority level which is lower than the first priority level is associated as the second priority level is included among the users who are already associated with the access information, for the access control section to replace the user identification information included in the access information with which the user who corresponds to the second priority level is associated with user identification information that corresponds to the user who corresponds to the first priority level so as to store the replaced user identification information in the access information storage section.

Moreover, it is also possible for the communication system of the present invention to be provided with a contents server which is connected to the plurality of user terminals, and for the contents server to be provided with: a contents storage section in which contents that are delivered to the server are stored; and a contents delivery section that delivers the contents stored in the contents storage section in accordance with contents delivery requests transmitted from the user terminals, and for comments that are associated with the contents to be stored in the comment storage section of the comment server.

Moreover, the present invention is also a communication method for a communication system which includes: a comment server which has a plurality of comment storage sections that store comments transmitted from a plurality of user terminals, and delivers the comments to the plurality of user terminals so that they are displayed thereon; and a user management server that has: a user information storage section which stores user identification information which identifies the user of the user terminal and user attribute information which shows the attributes of that user in association with each other, as user information, and an access information storage section which receives requests from the user terminals to connect to a communication service which is provided by the comment server and which stores access identification information which identifies an access destination in accordance with the number of users who have been permitted to connect to the communication service, access conditions which show the attributes of the users of this access destination, the user identification information which identifies the user terminals of this access destination, and connection destination information which specifies one comment storage section from among a plurality of comment storage sections that are provided in the comment server in order to store the comments transmitted from the user terminals of this access destination in association with each other, as access information, and the communication method includes: a step in which, when the connection request transmitted from the user terminal is received, the user attribute information that corresponds to that user terminal is read from the user information storage section, and whether or not there is access information with which the user identification information has not been associated among the plurality of access information items that satisfy the access conditions in accordance with the read user attribute information is determined by the user management server; a step in which, if it is determined that there is access information with which the user identification information has not been associated, the user management server permits the connection and associates the relevant user terminal with the relevant access information and stores this association in the access information storage section, while if it is determined that there is not such access information, the user management server does not permit the connection and does not associate the relevant user terminal with the relevant access information; a step in which, when the comments transmitted from the user terminals are received, the comment server stores the received comments in that comment storage section out of the plurality of comment storage sections which is specified by the connection destination information which has been stored so as to correspond to the relevant user terminal; and a step in which the comments stored in the comment storage section are delivered by the comments server to the user terminal with which the relevant comment storage section is associated as connection destination information.

Moreover, the present invention is also a user management server in a communication system which includes: a comment server that receives comments transmitted from a plurality of user terminals and stores them in any one of a plurality of comment storage sections, and then delivers the relevant comments to the plurality of user terminals that correspond to the relevant comment storage section so that they are displayed thereon; and a user management server that receives requests to connect to a communication service which is provided by the comment server from the user terminals, wherein the user management server includes: a user information storage section which stores user identification information which identifies the user of the user terminal and user attribute information which shows the attributes of that user in association with each other, as user information; an access information storage section which stores access identification information which identifies an access destination in accordance with the number of users who have been permitted to connect to the communication service, access conditions which show the attributes of the users of this access destination, the user identification information which identifies the user terminals of this access destination, and connection destination information which specifies one comment storage section from among a plurality of comment storage sections that are provided in the comment server in order to store the comments transmitted from the user terminals of this access destination in associated with each other, as access information; and an access control section that receives the connection request transmitted from the user terminal, reads the user attribute information that corresponds to the relevant user terminal from the user information storage section, and determines whether or not there is access information with which the user identification information has not been associated among the plurality of access information items that satisfy the access conditions in accordance with the read user attribute information, and if it determines that there is access information with which the user identification information has not been associated, permits the connection and associates the relevant user terminal with the relevant access information and stores this association in the access information storage section, while if it determines that there is not such access information, does not permit the connection and does not associate the relevant user terminal with the relevant access information.

### Effects of the Invention

As has been described above, according to the present invention, a user management server stores access information which is created by associating each item of access identification information, which identifies an access destination in accordance with the number of users who have been permitted to connect, together with access conditions which show the attributes of users who are to be associated with the access destination, and with user identification information which identifies the user terminals associated with this access destination, and with connection destination information which identifies a comment storage section where the comments transmitted from the user terminals are stored, and when a connection request is received from a user terminal, then if a vacancy exists in the access information which has been associated with the corresponding access conditions, the connection is permitted, and if a comment server receives a comment transmitted from a user terminal, it shares this comment with the user terminals with which this same connection destination information has been associated. As a result of this structure being employed, it is possible to provide a communication system that, when users who are using a communication service are divided into arbitrary division units, makes it possible for user terminals with which the same attributes are associated to be allocated to the same division unit, so that communication is able to proceed smoothly.

### BRIEF DESCRIPTION OF THE DRAWINGS

FIG. 1 is a block diagram showing a communication system according to an embodiment of the present invention.

FIG. 2 is a view showing an example of data stored in a seat information storage section according to an embodiment of the present invention.

FIG. 3 is a view showing an example of a screen displayed on a user terminal according to an embodiment of the present invention.

FIG. 4 is a flowchart showing an example of an operation performed by a communication system according to an embodiment of the present invention.

### EMBODIMENTS CARRYING OUT THE INVENTION

Hereinafter, an embodiment of the present invention will be described with reference made to the drawings.

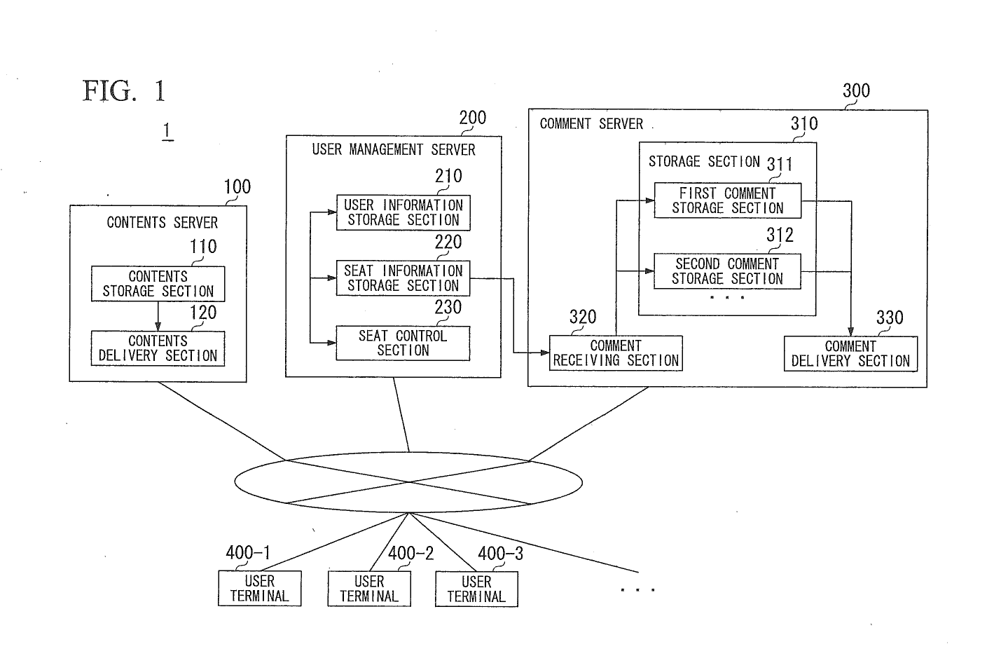

FIG. 1 is a block diagram showing the structure of a communication system 1 according to the present embodiment. The communication system 1 is provided with a contents server 100, a user management server 200, a comment server 300, a plurality of user terminals 400 (i.e., a user terminal 400-1, a user terminal 400-2, a user terminal 400-3, . . . a user terminal 400-n, . . . a user terminal 400-N). These component elements are formed by computer devices and are connected together via a network. Here, because the plurality of user terminals 400-N (wherein N is an arbitrary integer) have the same structure, other than when any special distinction is to be made, the generic descriptor ‘user terminals 400’ is used.

The contents server 100 is a computer device that delivers contents that are played by a plurality of user terminals. The contents server 100 is provided with a contents storage section 110 and a contents delivery section 120.

The contents storage section 110 stores contents that are delivered to the user terminals 400 and are played thereon. The contents that are stored in the contents storage section 110 include, for example, information such as video or audio that has a time axis. The contents stored in the contents storage section 110 may be information that is stored in advance, or may be information that is created in real time. For example, the information may be video information about a cooking program that has been previously recorded, or may be video information that is input in real-time by a live broadcast and stored.

The contents delivery section 120 delivers the contents stored in the contents storage section 110 in accordance with contents delivery requests transmitted from the user terminals 400.

The user management server 200 is a computer device that receives from the user terminals 400 connection requests to connect to a communication service which is provided by the contents server 100 and the comment server 300. The user management server 200 is provided with a user information storage section 210, a seat information storage section 220, and a seat control section 230.

The user information storage section 210 associates user identification information which identifies the user of a user terminal 400 with user attribute information which shows the attributes of that user, and then stores the result. The information created when user attribute information is added to the relevant user identification information item is known as user information. Information showing the priority ranking of a particular user is included in the user information stored in the user information storage section 210. The information showing the priority ranking of a user may be displayed, for example, using numerical information, and user points and the like awarded by the communication service can be applied thereto. Alternatively, if, for example, both paying users and non-paying users subscribe to the communication service, then a flag value indicating whether the user is a paying user or a non-paying user can be applied to the information showing the priority ranking of that user. In this case, paying users have a higher priority than non-paying users. In the present embodiment, an example is described in which this type of priority flag is assigned to a user. Examples of other types of user information include, for example, the user's name, handle name, date of birth, gender, blood type, address, and the like.

The seat information storage section 220 creates associations between the following groups of information and also stores these information associations. Namely, the seat information storage section 220 associates access identification information which identifies an access destination which corresponds to the number of users who have been permitted to connect to the communication service together with access conditions (i.e., first seating conditions) which show attributes of the users of the access destination, and with user identification information which identifies user terminals of the access destination, and with connection destination information which identifies the comment storage section where comments transmitted from user terminals of the access destination are stored. The information created when the access conditions, user identification information, and connection destination information are attached to the relevant access identification information item is known as access information. The aforementioned comment storage section is one of a plurality of comment storage sections that are provided in a comment server (described below).

In the present embodiment, participation in a communication service is thought of as having a virtual seat, while the access identification information is seat identification information that identifies this type of virtual seat. In the same way, the access conditions are seating conditions (i.e., conditions to be satisfied before a seat can be taken), and the access information is seating information (i.e., information relating to taking a seat). The seat identification information may be, for example, information such as a reference number which is formed solely by a numerical value, or information which is a combination of numerical values and alphabetic characters, or information that uniquely identifies the access destination of a user. Temporary attribute information which shows the attributes of a user which have been decided temporarily by that user are stored in the seat information storage section 220 as second seating conditions. The second seating conditions may be, for example, the response to a question which has been posed to the user.

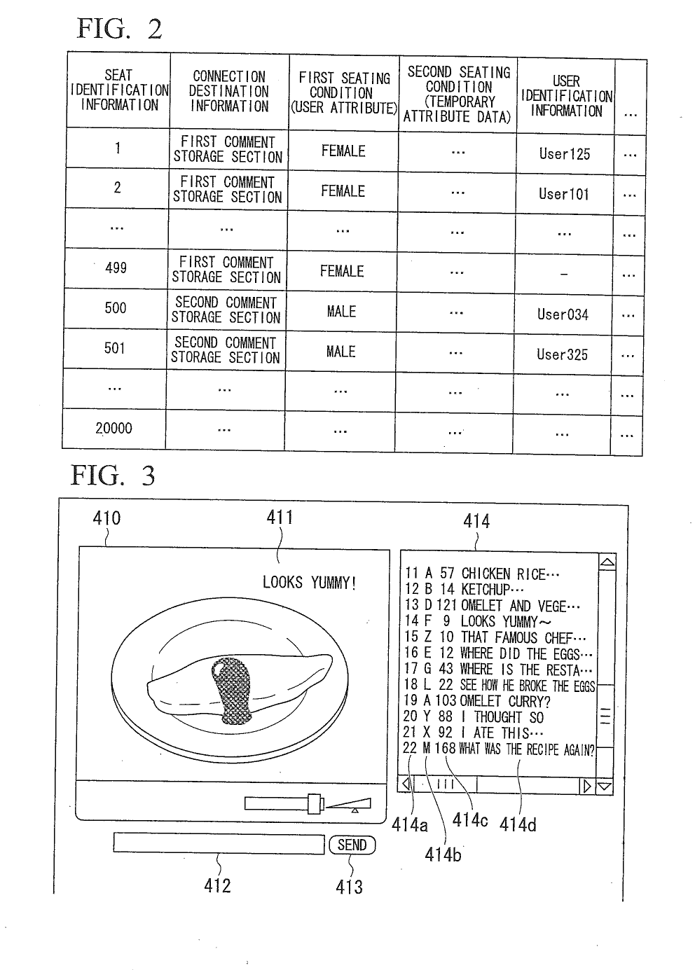

An example of data which is stored in the seat information storage section 220 will now be described with reference made to FIG. 2. Here, at this stage when the communication system 1 has started to provide a communication service, information which includes the seat identification information, the connection destination information, the first seating conditions, and the second seating conditions is input in advance by an administrator and stored. User identification information for users who it has been determined by the seat control section 230 are permitted to connect is stored in the user identification information. For example, in FIG. 2, the user identification information [User 125] is associated with the seat information whose seat identification information is [1], while the user identification information [User 101] is associated with the seat information whose seat identification information is [2]. In contrast, the user identification information corresponding to the seat identification information [499] is shown as [-], and this shows that this information has not yet been associated with a user.

In this example, it is assumed that the number of users who are permitted to connect to this communication service is 20,000, and that seat identification information for 1 through 20,000 has been previously stored. The fact that the user must be female is set as the first seating condition for the seats whose seat identification information numbers are from 1 through 499. In this case, only users whose gender is shown as female in the user attribute information are associated with the seats whose seat identification information numbers are from 1 through 499, and are allowed to take a virtual seat. Here, the same connection destination information (i.e., from the first comment storage section) is associated with the seats whose seat identification information numbers are from 1 through 499. As is described below, by using the same comment storage section for the connection destination information, comments transmitted from the user terminals 400 are only shared between user terminals that belong to the same virtual room. Namely, users who are associated with seats whose seat identification information numbers are from 1 through 499 end up belonging to the same room.

When the seat control section 230 receives a connection request transmitted from the user terminal 400-n, it reads the user attribute information that corresponds to the user terminal 400 from the user information storage section 210. Next, the seat control section 230 determines whether or not seat information with which no user identification information has been associated (i.e., awarded) exists among the plurality of seat information items that correspond to the seating conditions matching the read user attribute information. If seat information with which no user identification information has been associated does exist, the seat control section 230 permits the connection, associates the user terminal 400-n with the seat information, and stores this fact in the seat information storage section 220. If, however, the aforementioned seat information does not exist, the seat control section 230 does not permit the connection and does not associate the user terminal 400-n with the seat information. For example, the first seating condition for the seats whose seat identification information numbers are from 1 through 499 is that the user is female, while the first seating condition for all of the other seats is that the user is male, and it is assumed that user identification information has already been associated with the seats whose seat identification information numbers are from 1 through 499. In this case, if a new connection request is transmitted from the user terminal 400-n, and the gender in the user attributes which correspond to that user terminal is female, then permission is not given for that user terminal to make a connection, and the seat information is not updated.

In addition, the seat control section 230 is also able to receive temporary attribute information transmitted from the user terminal 400 together with the connection request, and then compare the received temporary attribute information with the seating conditions stored in the seat information storage section 220 so as to determine which seat information a user terminal 400 is to be associated with. For example, if a communication service is provided for baseball followers of team A and team B, then seat information that is used to allocate users to either a room for followers of team A or a room for followers of team B is stored in advance in the seat information storage section 220. When a connection request is received from a user terminal 400, an input of information showing which team that particular user supports is received as temporary attribute information, and that user is associated with a seat which corresponds to seating conditions that match the input temporary attribute information. By employing such a method, room allocation can be performed flexibly without depending solely on the user information stored in advance in the user information storage section 210.

Moreover, if the seat control section 230 determines that seat information with which user identification information has not been associated does not exist among the plurality of seat information items that correspond to the seating conditions which match the user attribute information for the user terminal 400-n, which is the source of the connection request transmission, then it is also possible to alter the associating of the seat information of a user while considering their priority. Namely, the seat control section 230 compares the priority (i.e., a first priority) of the user terminal 400-n, which is the source of the connection request transmission, with the priority (i.e., a second priority) of a user already associated with seat information. If a user whose priority is lower than the priority of the user terminal 400-n is included among the users who have already been associated with seat information, the seat control section 230 replaces the user identification information associated with the seat information with which the low priority user was associated with user identification information that corresponds to the higher priority user, and then stores this in the seat information storage section 220.

Here, an example is described in which both priority users to whom a priority flag indicating priority is applied, and who are shown to be paying users by being provided with this priority flag, and non-priority users who are shown to be non-paying users exist. It is assumed that, of the user information for 1 through 20,000 which is stored in the seat information storage section 220, user identification information has already been associated with all of the seats whose seat identification numbers are from 1 through 499 and whose first seating condition is that the user is female. In this case, it is assumed that a new connection request has been transmitted from the user terminal 400-n whose attributes show a female and a priority user. In this case, the seats whose first seating condition is that the user is female are full, however, the seat control section 230 extracts user identification information for already associated non-priority users, and rewrites it with the user identification information of the priority user.

The comment server 300 is a computer device that receives comments transmitted from the user terminals 400 in accordance with contents played by the user terminals 400, and then delivers the received comments to a plurality of user terminals 400 so that they are displayed thereon. The comment server 300 is provided with a storage section 310, a comment receiving section 320, and a comment delivery section 330.

The storage section 310 stores comments transmitted from the user terminals 400. The storage section 310 is provided with a plurality of comments storage sections that, among the comments transmitted from the plurality of user terminals 400 which have been permitted to connect, store those comments transmitted from each associated user terminal 400. Here, the description uses a first comment storage section 311 and a second comment storage section 312 as examples, however, it is also possible to provide a desired number of comment storage sections corresponding to the number of rooms. Moreover, specifically, the comment storage sections may be, for example, database tables.

When the comment receiving section 320 receives a comment transmitted from the user terminal 400-n, it stores the received comment in the comment storage section 311 or 312, from among the plurality of comment storage sections, which is specified by connection destination information stored to correspond to the user terminal 400-n. For example, if a comment is transmitted from the user terminal 400-n to which the first comment storage section 311 has been allocated as the connection destination information, the received comment is stored in the first comment storage section 311.

The comment delivery section 330 delivers comments stored in the plurality of comment storage sections to the relevant user terminal 400 which uses that comment storage section as connection destination information. For example, a comment which is stored in the first comment storage section 311 is delivered to the user terminal 400 which is identified by the user identification information which was associated with the connection destination information having the first comment storage section 311 as its connection destination and was then stored. Here, for example, the comment delivery section 330 reads from the seat information storage section 220 of the user management server 200 user identification information which is contained in the access information in which the same comment storage section is stored as connection destination information, and delivers the read user identification information to the user terminal 400 as an address.

The user terminal 400 is a computer device which plays the contents delivered from the contents server 100, and attaches comments delivered from the comment server 300 to these contents and outputs the result. FIG. 3 shows an example of a screen displayed on the user terminal 400. Video delivered from the contents server 100 and a comment 411 transmitted from another user terminal 400 and delivered by the comment server 300 are displayed superimposed on top of one another on a play area 410 within the screen. The comment 411 delivered from the comment server 300 is displayed so that it scrolls smoothly over the video from the right to the left. As a result, while viewing the video, a user of this communication service is able to share comments which are input in accordance with the video content with other users, and thus achieve communication with other users.

Comments are input via an input unit such as a keyboard or a mouse into an input form 412. When a send button 413 is clicked, it transmits the comments that have been input into the input form 412, and also the comment input time, video identification information, and user identification information and the like to the user management server 200 and the comment server 300.

Comments input from a plurality of users are displayed in a comment list display area 414. Listed comments are received at regular intervals from the comment server 300 by a transmitting-receiving section of the user terminal 400, and are stored in a storage area of the user terminal 400. Numbers 414a which show the submission sequence of each comment, usernames 414b of the users who input the comments, comment submission times 414c showing when the comments were sent, and portions 414d of the submitted comments are displayed in the sequence of the time at which they were submitted in the comment list display area 414.

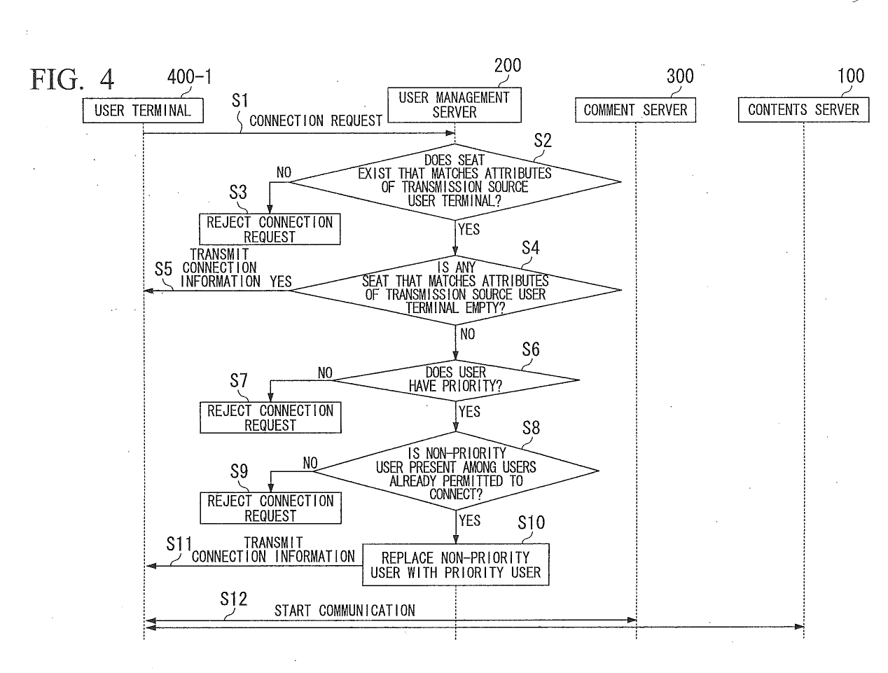

Next, an example of an operation of the communication system 1 of the present embodiment will be described. An example of an operation in which the user terminal 400-1 which has made a connection request to the communication system 1 starts to use a communication service will now be described with reference made to FIG. 4. In accordance with the input of operation information by a user, the user terminal 400-1 transmits to the user management server 200 a connection request which includes user identification information identifying the user terminal 400-1 (step S1). The user who corresponds to the user terminal 400-1 may have already completed login by using an account that has previously been registered with the communication service, or may login at the same time the connection request is made.

The seat control section 230 of the user management server 200 receives the connection request transmitted from the user terminal 400-1, and reads from the user information storage section 210 the user information that corresponds to the user identification information included in the received connection request. The seat control section 230 determines whether or not seat information with which seating conditions that match the attributes indicated by the read user information have been associated is present (step S2). If second seating conditions are included in the seat information, the user management server 200 receives temporary attribute information together with the connection request transmitted from the user terminal 400-1. Next, it compares the temporary attribute information transmitted from the user terminal 400-1 with the second seating conditions included in the seat information, and determines the seat information with which second seating conditions that match the temporary attribute information have been associated.

If the seat control section 230 determines that seat information with which seating conditions that match the attributes of the user terminal 400-1 have been associated is not present (i.e., step S2: NO), the connection request is rejected and the processing is ended (step S3). If, however, the seat control section 230 determines that seat information with which seating conditions that match the attributes of the user terminal 400-1 have been associated is present (i.e., step S2: YES), it determines whether or not there is an empty seat that complies with the seating conditions which match the attributes indicated by the read user information, and with which user identification information has not been associated (step S4).

If the seat control section 230 determines in step S4 that there is such an empty seat (i.e., step S4: YES), the seat control section 230 transmits connection information to the user terminal 400-1 (step S5). The connection information is, for example, information showing the connection destination of the seat associated with the user, and information such as addresses that are used to connect to the contents server 100 and the comment server 300. If access to the contents server 100 and the comment server 300 is restricted, then information such as passwords for accessing the contents server 100 and the comment server 300 may also be included in the connection information.

If the seat control section 230 determines in step S4 that there is no such empty seat (i.e., step S4: NO), the seat control section 230 determines whether or not the user of the user terminal 400-1 is a priority user (step S6). In the present embodiment, it determines whether or not the user is a priority user by means of the priority flag allocated to the user. If the seat control section 230 determines that the user of the user terminal 400-1 is not a priority user (i.e., step S6: NO), the connection request is rejected (step S7).

If, however, in step S6 the seat control section 230 determines that the user of the user terminal 400-1 is a priority user (i.e., step S6: YES), it determines whether or not a non-priority user is present among the users who have already been granted permission to connect (step S8). Here, if the seat control section 230 determines that a non-priority user is not present among the users who have already been granted permission to connect (i.e., step S8: NO), it rejects the connection request (step S9).

If, however, the seat control section 230 determines that a non-priority user is present among the users who have already been granted permission to connect (i.e., step S8: YES), it extracts the non-priority user from among the users who have already been granted permission to connect, and replaces the user identification information in the seat information with which the extracted non-priority user has been associated with that of the priority user (step S10). Next, the seat control section 230 transmits connection destination information to the user terminal 400-1 (step S11). Based on this received connection destination information, the user terminal 400-1 then commences communication with the comment server 300 and the contents server 100 (step S12). Thereafter, the user terminal 400-1 transmits a contents delivery request to the contents server 100, and displays both the contents that were delivered from the contents server 100 in accordance with the received contents delivery request, and comments that were delivered from the comment server 300 in accordance with the contents. When the comments are input into the user terminal 400-1, the user terminal 400-1 transmits the input comments to the comment server 300. The comment server 300 stores the comments transmitted from the user terminal 400-1 in the storage section 310, and also delivers them to the plurality of user terminals 400 with which this same comment storage section has been associated.

As has been described above, according to the present embodiment, users who have common attributes are associated with the same room, and comments are shared solely between user terminals 400 that belong to the same room. Accordingly, it is possible to provide communication in which, as a prerequisite, the users have common attributes. As a result, if a communication service provider wishes to provide a communication site having the theme of, for example, ‘girl talk’, then it is possible to limit the users who are permitted to connect to that service to females. Consequently, it is possible to provide a communication site that conforms to the intention of the provider.

Conventionally, when, for example, several tens of thousands of users are using a communication service, then if a priority user subsequently sends a connection request, in order to perform control such that the connection of a non-priority user who was already connected is severed, and the connection of the priority user is established, it has been necessary to replace connected user terminals by individually connecting and disconnecting each session. In contrast to this, according to the present embodiment, by detecting a non-priority user from the seat information stored in the seat information storage section 220, and rewriting the user identification information associated with the detected seat with the user identification information of a priority user, it is possible to easily replace a connection.

Note that it is also possible to record a program that achieves the functions of the processing sections of the present invention on a computer-readable recording medium, and to provide a communication service by causing a computer system to read and execute the program recorded on this recording medium. Note that the term ‘computer system’ used here includes both OS and hardware such as peripheral devices and the like. Moreover, ‘computer system’ may also include a WWW system which is provided with a homepage providing environment (or display environment). Moreover, the term ‘computer readable recording medium’ also refers to portable media such as flexible disks, magneto-optical disks, ROM, and CD-ROM and the like, and storage devices such as hard disks that are built into a computer system. Furthermore, ‘computer readable recording medium’ also includes devices that hold a program for a fixed time such as the internal volatile memory (RAM) in a computer system which forms the server or client when the program is transmitted via a network such as the Internet or via a communication line such as a telephone line.

Moreover, the aforementioned program may also be transmitted from a computer system in which the program is stored on a storage device or the like to another computer system via a transmission medium, or via a transmission wave within the transmission medium. Here, the term ‘transmission medium’ which transmits the program refers to a medium having a function of transmitting information such as a network such as the Internet or a communication line such as a telephone line. Moreover, the above described program may also be designed to fulfill a portion of the above described functions. Furthermore, the aforementioned program may also achieve the above described functions in combination with a program which is already recorded on the computer system, or may be what is known as a differential file (i.e., a differential program).

### INDUSTRIAL APPLICABILITY

The present invention can be applied to a communication service in which comments which are input in accordance with the progress of contents played on a plurality of user terminals that are mutually connected via a network are shared by the plurality of users, and the present invention is able to provide a communication service based on a user number that makes smooth communication possible.

### REFERENCE SYMBOLS

1 Communication system
100 Contents server
110 Contents storage section
120 Contents delivery section
200 User management server
210 User information storage section
220 Seat information storage section
230 Seat control section
300 Comment server
310 Storage section
311 First comment storage section
312 Second comment storage section
320 Comment receiving section
330 Comment delivery section
400 User terminal
410 Play area
411 Comment
412 Input form
413 Send button
414 Comment list display area

1-6. (canceled)

7. A communication system providing a communication service in which comments transmitted from a plurality of user terminals are delivered to and displayed on the user terminals, comprising:
a plurality of comment storage sections which store the comments transmitted from the user terminals;
a user information storage section which stores, as user information, user identification information which identifies users of the user terminals and user attribute information which shows attributes of the users in association with each other;
an access information storage section which stores, as access information, access identification information which identifies access destination, access condition which shows the attributes of the users for accessing the access destination, and connection destination information which selects one of the comment storage sections for storing the comments transmitted from the user terminals accessing to the access destination, in association with each other;
an access control section which receives a connection request for the communication service transmitted from the user terminals, reads the user attribute information associated with the user terminals from the user information storage section, and permits the user terminals to access to the access destination when the user attribute information read from the user information storage section satisfy the access conditions;
a comment receiving section which receives the comments transmitted from the user terminals, and stores the received comments in the comment storage section selected by the connection destination information in association with the access destination; and
a comment delivery section which delivers the comments stored in the comment storage section selected by the connection destination information to the user terminals accessing to the access destination.

8. The communication system according to claim 7, wherein:
the access information storage section stores temporary attribute information which shows the attributes temporarily decided as the access condition; and
the access control section receives the temporary attribute information from the user terminals and permits the user terminals to access to the access destination when the received temporary attribute information satisfy the access conditions.

9. The communication system according to claim 7, wherein:
the user information stored in the user information storage section includes information showing a priority of the user; and
the access control section permits the user terminal having high priority to access to the access destination prior to the user terminal having low priority when a number of access to the access destination exceeds a predetermined upper limit.

10. The communication system according to claim 7, comprising:
a contents storage section which stores content to be delivered to the user terminals; and
a contents delivery section which delivers the content stored in the contents storage section in response to a content delivery request transmitted from the user terminals, wherein
the comment storage sections store comments that are associated with the content.

11. A method for providing a communication service, comprising the steps of:
preparing a communication system including: a plurality of comment storage sections which store comments transmitted from user terminals; a user information storage section which stores, as user information, user identification information which identifies users of the user terminals and user attribute information which shows attributes of the users in association with each other; and an access information storage section which stores, as access information, access identification information which identifies access destination, access condition which shows the attributes of the users for accessing the access destination, and connection destination information which selects one of the comment storage sections for storing the comments transmitted from the user terminals accessing to the access destination, in association with each other;
receiving a connection request for the communication service transmitted from the user terminals;
reading the user attribute information associated with the user terminals from the user information storage section;
permitting the user terminals to access to the access destination when the user attribute information read from the user information storage section satisfy the access conditions;
receiving the comments transmitted from the user terminals;
storing the received comments in the comment storage section selected by the connection destination information in association with the access destination; and
delivering the comments stored in the comment storage section selected by the connection destination information to the user terminals accessing to the access destination.

12. A communication system providing a communication service in which comments transmitted from a plurality of user terminals are delivered to and displayed on the user terminals, comprising:
a plurality of comment storage sections which store the comments transmitted from the user terminals;
an access information storage section which stores, as access information, access condition which shows user attributes of the user terminals, and connection destination information which selects one of the comment storage sections for storing the comments transmitted from the user terminals whose user attributes satisfying the access condition, in association with each other;
a comment receiving section which stores the comments transmitted from the user terminals whose user attributes satisfying the access condition in the comment storage section selected by the connection destination information; and
a comment delivery section which delivers the comments stored in the comment storage section selected by the connection destination information to the user terminals whose user attributes satisfying the access condition.
